(19) United States
(12) Patent Application Publication
(10) Pub. No.: US 2011/0001347 A1
(43) Pub. Date: Jan. 6, 2011

(54) CUSHION SHEET FOR CHAIR AND METHOD OF MANUFACTURING THE SAME

(75) Inventor: Jin-Young Choi, Incheon (KR)

Correspondence Address: CANTOR COLBURN LLP, 20 Church Street, 22nd Floor, Hartford, CT, 06103, US

(73) Assignee: IOS CO., LTD., Incheon (KR)

(21) Appl. No.: 12/667,438

(22) PCT Filed: May 20, 2008
(86) PCT No.: PCT/KR08/02810

§ 371 Date: Dec. 31, 2009

(30) Foreign Application Priority Data
Jul. 4, 2007 (KR) 10-2007-0067242

(51) Int. Cl. A47C 7/02; B32B 37/02; B29C 65/02

(52) U.S. Cl. 297/452.61; 156/60

(57) ABSTRACT

A cushion sheet for a chair is disclosed. The cushion sheet includes an adhesion part (11), which has a curvature corresponding to that of the frame of the chair, cushion cells (12), which are formed by the adhesion part, and ventilation passages (13), which are defined between the cushion cells. Each cushion cell includes a base layer (22), a cover layer (21) and a sponge layer (23), which is provided between the base layer and the cover layer. The ventilation passages are defined by extending portions of the cover layer around the cushion cells such that extended portions of the cover layer are brought into close contact with the base layer. The adhesion part is formed by adhering the extended portions of the cover layer to the base layer using a sponge hot melt, which is formed by melting portions of the sponge layer corresponding to the ventilation passages.

### TECHNICAL FIELD

The present invention relates, in general, to cushion sheets for chairs and methods of manufacturing the cushion sheets and, more particularly, to a cushion sheet for chairs, which are used as office chairs, furniture chairs including chairs for resting, and seats for vehicles.

### BACKGROUND ART

Generally, cushion sheets for furniture chairs include seat parts, on which users sit, and back parts, which support the backs of the users. Such a chair cushion sheet requires compatibility with the human body, because it directly contacts the body of a user. Compared to the cushion sheets for furniture chairs, cushion sheets for vehicle seats must have more various features relating to the comfort of users. Under vehicular conditions, shaking of the vehicles or vibrations thereof attributable to the notion of the vehicles are transmitted to the vehicle seats. Furthermore, the cushion sheets for vehicle seats must consider the case where users sit on the vehicle seats for a very long time. As well, typically, the cushion sheets for vehicle seats come into close contact with drivers or passengers to ensure their safety. When users sit on the vehicles seats, space for bodily movement is relatively small, and, of course, a swivel chair cannot be used. As such, vehicle seats restrict the sitting posture of the users. Considering the conditions of users who work for a long time while sitting on chairs, cushion sheets are closely connected with the health and work efficiency of the users. When taking the above factors into account, the cushion sheets for chairs including vehicle seats must be able to come into close contact with the bodies of the users, have superior contact stability, superior ventilation ability, superior insulation ability, and ensure lightness.

As investigated in the present invention, the three most important factors for cushion sheets for chairs are i) the suitability to the human body, ii) the cushion stability and iii) ventilation ability. Cushion sheets having superior quality may enhance the work efficiency of users. Furthermore, because the cushion sheets for chairs are directly connected with the correct postures and health of the users, the manufacture thereof must be cautiously conducted.

Conventional cushion sheets for chairs have cushion cells, in which elastic members are covered with outer shells, and each cushion cell has a circular shape and is relatively large. Typically, one or two cushion cells are provided on such a conventional cushion sheet. The elastic cells are brought into close contact with the body of a user. However, in the conventional technique, because each cushion cell is relatively large, the suitability to the human body, the cushion stability and ventilation ability cannot be ensured. Furthermore, in the case of the conventional chairs, to increase the ventilation ability of a chair, a separate bead cushion is placed on the seat part of the chair, or a separate power-driven ventilation device is installed on the chair. However, such a separate cushion or device, which is provided on the cushion sheet for the chair, may deteriorate the external appearance of the chair, make the user tired, or make the sitting posture of the user incorrect, with the result that the health of the user may be ruined.

### DISCLOSURE OF INVENTION

### Technical Problem

Accordingly, the present invention has been made keeping in mind the above problems occurring in the prior art, and an object of the present invention is to provide a cushion sheet for chairs which has superior suitability to a human body. Another object of the present invention is to provide a cushion sheet for chairs which has superior cushion stability. A further object of the present invention is to provide a cushion sheet for chairs which has superior ventilation ability. Yet another object of the present invention is to provide a cushion sheet for chairs in which cushion cells are arranged into a tortoise-shell shape. Still another object of the present invention is to provide a cushion sheet for chairs in which, depending on positions of the cushion cells which contact parts of the human body, the cushion cells are formed into an arrangement corresponding to respective parts of the human body. Still another object of the present invention is to provide a cushion sheet for chairs in which the cushion cells are arranged such that when the cushion sheet is attached to a frame of a chair, the design of the chair can be expressed through the cushion sheet. Still another object of the present invention is to provide a cushion sheet for chairs which can be designed in various colors. Still another object of the present invention is to provide a cushion sheet for chairs in which ventilation passages are formed between the cushion cells. Still another object of the present invention is to provide a cushion sheet for chairs which is neat, graceful and elegant. Still another object of the present invention is to provide a cushion sheet for chairs which can be easily manufactured and which can be easily adapted to mass production. Still another object of the present invention is to provide a cushion sheet for chairs which can be easily controlled in quality.

### Technical Solution

In order to accomplish the above objects, the present invention provides a cushion sheet for chairs which has superior suitability to a human body, superior cushion stability and superior ventilation ability. The term “suitability to the human body” means that the cushion sheet is curved at a curvature corresponding to the outline of the body of a user who is healthy such that the cushion sheet can appropriately disperse the weight of the user. The outline of the human body is reflected in the design of a frame of a chair, so that the suitability to the human body can be achieved by expressing the design line of the frame of the chair through the cushion sheet. Furthermore, the suitability to the human body can be achieved by dividing the cushion part of the cushion sheet into the small cushion cells and by supplying a cushion sheet, which has even thickness and elasticity. In addition, in the present invention, the cushion part of the cushion sheet is divided into the cushion cells, around which is formed an adhesion part, thus preventing the cushion cells from undesirably moving which would cause the cushion cells to exhibit unstable cushion functions. In the present invention, ventilation passages to ensure superior ventilation ability are formed between the cushion cells. Therefore, even when the weight of the user is on the cushion sheet, a sufficient amount of air flows between the cushion cells. In the present invention, the ratio of the area of the ventilation passages to the area of the cushion sheet is determined in consideration of a difference in pressures at which different regions of the cushion sheet come into contact with the respective parts of the body of the user. Hence, the entirety of regions of the cushion sheet which contact the body of the user can exhibit reliable ventilation ability. Furthermore, in the present invention, the cushion cells and the ventilation passages can be designed in various arrangements, so that aesthetic value and dignity of the chair can be enhanced.

Hereinafter, preferred embodiments of the present invention will be described in detail. A cushion sheet for a chair according to the present invention has an adhesion part 11, which has a curvature corresponding to that of a pre-designed frame 51 of a chair, a plurality of cushion cells 12, which are held in place by the adhesion part 11, and ventilation passages 13, which are defined on the adhesion part 11 and located between the cushion cells 12.

Each cushion cell 12 includes a base layer 22, a cover layer 21 and a sponge layer 23. The sponge layer 23 is made of thermal fusion polyurethane and is provided between the base layer 22 and the cover layer 21 to elastically support the cover layer 21.

The ventilation passages 13 are defined by pressing portions of the cover layer 21 around the cushion cells 12 such that extended portions of the cover layer 21 are brought into close contact with the base layer 22, and the portions of the thermal fusion polyurethane sponge layer corresponding to the ventilation passages 13 area are melted by heating and pressing. The adhesion part 11 is formed by adhering the pressed portions of the cover layer 21 to the base layer 22 using a sponge hot melt, formed by melting portions of the sponge layer corresponding to the ventilation passages.

In the cushion sheet, the sizes of, distribution of, and the area ratio between the cushion cells 12 and the ventilation passages 22 may vary depending on positions of the cushion cells 12 which contact parts of a user's body.

Furthermore, depending on the parts of the user's body, the shapes and colors of the cushion cells 12 are determined. In addition, the cushion cells 12 have an identical thickness and planar shapes, and are arranged such that the cushion sheet has a curvature corresponding to the curvature of the frame 51 of the chair.

A method of manufacturing the cushion sheet according to the present invention includes a cover layer adhering step. At this step, the thermal fusion polyurethane sponge layer 23, which is melted at a temperature ranging from 110° C. to 160° C., is prepared. A sponge hot melt is formed on a first surface of the sponge layer to a relatively thin thickness by heating the first surface of the sponge layer using a flame. The sponge hot melt, which is thus formed by melting the sponge, serves as an adhesive when it is cooled and hardened. Thereafter, the cover layer 21, which withstands temperatures of 170° C. and serves as the outer surface of the cushion sheet, is placed on the first surface of the sponge layer. The cover layer 21 has, functioning as the outer surface of the cushion sheet, a smooth texture, an appropriate density and superior durability and can be easily cleaned. Furthermore, the cover layer 21 has the elasticity appropriate to shaping it. Subsequently, the cover layer 21 is compressed onto the first surface of the sponge layer 12, and the hot melt between the cover layer 21 and the sponge layer 12 is cooled, thus adhering the cover layer 21 to the first surface of the sponge layer 12.

The method of manufacturing the cushion sheet further includes a base layer adhering step. At the base layer adhering step, a sponge hot melt of a relatively thin thickness is formed on a second surface of the thermal fusion polyurethane sponge layer 23 by heating the second surface of the sponge layer using a flame. Thereafter, the base layer 22, which withstands at a temperature of 170° C., is placed on the second surface of the sponge layer. Subsequently, the base layer 22 is compressed onto the second surface of the sponge layer 12 and the hot melt between the base layer 22 and the sponge layer 12 is cooled, thereby adhering the base layer 22 to the second surface of the sponge layer 12.

The method of manufacturing the cushion sheet further includes a shaping step. At the shaping step, the thermal fusion polyurethane sponge layer 23, to which the base layer 22 and the cover layer 21 have been adhered to and which have a sandwich shape, and which is melted at a temperature ranging from 110° C. to 160° C., is placed between a lower mold 43 and an upper mold 41, which has forming punches 42 corresponding to the ventilation passages 13. Thereafter, the forming punches 42 are heated to 170° C., at which temperature the portions of the sponge layer 23 corresponding to the ventilation passages 13 are melted. Subsequently, the forming punches 42 press the upper surface of the sponge layer 23 at a pressure ranging from 80 kg/cm² to 100 kg/cm², thus simultaneously forming the cushion cells 12 in the sponge layer 23 on the base layer 22, and also forming the ventilation passages 13. Simultaneously, a sponge hot melt, which is formed by melting the portions of the sponge layer corresponding to the ventilation passages 13, is applied to the base layer 22 and the pressed portions of the cover layer 21 which is brought into close contact with the base layer 22.

The method of manufacturing the cushion sheet further includes an adhering step of adhering the pressed portions of the cover layer 21 to the base layer 22 by the cooling and hardening of the sponge hot melt, which is applied to the portions of the base layer 22 and the cover layer 21 corresponding to the ventilation passages, so that the shape of the cushion sheet which had been formed at the shaping step is preserved, thereby forming the adhesion part 11.

The thermal fusion polyurethane sponge layer 23 has a thickness ranging from 2 cm to 5 cm. To enhance the efficiency of the process of manufacturing the cushion sheet, the thermal fusion polyurethane sponge layer 23 may be manufactured by overlapping two sheets of sponge, that is, an upper sponge layer and a lower sponge layer, into which the sponge layer 23 is divided in a thicknesswise direction. In this case, the cover layer 21 is adhered to the upper sponge layer, and the base layer 22 is adhered to the lower sponge layer through separate processes. Thereafter, the upper and lower sponge layers are adhered to each other, thus forming the cushion sheet.

Thermal fusion polyurethane sponge used in this embodiment of the present invention has a density ranging from 26 kg/m3 to 30 kg/m3, a hardness ranging from 11 kg/cm² to 15 kg/cm² and a melting point ranging from 110° C. to 160° C. A sponge hot melt, which is formed by melting sponge, exhibits adhesive ability when being hardened. In the present invention, when the thermal fusion polyurethane sponge layer 23 is pressed by the ventilation passage forming punches 42, which are heated at a temperature ranging from 150° C. to 170° C., the portions of the sponge layer 23 corresponding to the ventilation passages 13 are melted by heat of the ventilation passage forming punches 42, so that the sponge layer delimits the ventilation passage 13 therein and forms the cushion cells 12. The sponge hot melt, which is formed by melting the portions of the sponge layer corresponding to the ventilation passages 13, is in the form of viscous liquid when it is at the heat of fusion. The viscous sponge hot melt is hardened into a solid body when it is cooled, thus adhering the cover layer 21 to the base layer 22.

Furthermore, in the present invention, the cover layer 21, which withstands temperatures of 170° C. and has, because functioning as the outer surface of the cushion sheet, a smooth texture, an appropriate density, superior durability, superior washability, and an elasticity appropriate to being shaped, is made of fabric and a plastic film or sheet, which has a grammage ranging from 40 g/m² to 250 g/m² and has unidirectional or bidirectional elasticity. In consideration of economic efficiency and practicality, it is preferable that the cover layer 21 of the cushion sheet be made of polyester stretch fabric having a grammage of 180 g/m².

The polyester stretch fabric can stably maintain texture of the cover layer even at a temperature ranging from 150° C. to 170° C., a temperature at which the sponge layer is melted. When the ventilation passages 13 are formed in the thermal fusion polyurethane sponge layer by pressing the portions of the sponge layer corresponding to the ventilation passages 13 using the forming punches 42 of the upper mold, the cover layer 21 made of polyester stretch fabric is extended such that the sidewalls of the ventilation passages 13 are covered with the cover layer 21. Simultaneously, the cover layer 21 is adhered to the base layer 22 by adhesive force of the sponge hot melt, thus forming the adhesion part 11. Here, after the shaping process is completed, the smooth to the touch feel and fine texture of the outer surface of the cushion sheet can be preserved and the washability thereof is superior, thus ensuring satisfactory features of the cushion sheet.

The base layer 22 is prevented from being deformed even at a temperature ranging from 150° C. to 170° C., at which temperature the thermal fusion polyurethane sponge layer is melted, and is firmly adhered to the cover layer by the hot melt, formed by melting the portions of the sponge layer. Furthermore, the base layer 22 serves to support the sponge layer 23 to prevent the sponge layer 23 from being undesirably displaced, after the shaping process of the sponge layer 23 is completed. In the present invention, the base layer has a grammage ranging from 8 g/m² to 40 g/m². In consideration of economic efficiency and practicality, it is preferable that the base layer 22 be made of a sheet of thermal resistant filament gauze having a grammage of 12 g/m².

The cushion cells 12 are formed by forming the ventilation passages 13 in the planar thermal fusion polyurethane sponge layer through the process of melting and pressing the portions of the sponge layer corresponding to the ventilation passages 13. Therefore, the cushion sheet can assume a planar shape having an even thickness. As such, the cushion cells of the cushion sheet have a planar surface shape and an identical thickness, so that when the cushion sheet is attached to the frame of the chair, the curvature of the pre-designed frame of the chair can be well expressed outside the cushion sheet.

Furthermore, in the cushion sheet of the present invention, the cushion cells 12 have different sizes depending on where the cushion cells 12 contact which parts of the user's body. The ratio of the area of the ventilation passages 13 to the area of cushion sheet ranges from 5% to 15% depending on their location and relation to the parts of the user's body. Each ventilation passage 13 has a width ranging from 1 cm to 4 cm. In embodiments of FIGS. 1 through 3, in the case of back portions A, B, E, F, H and J of the chairs, a ratio of the area of the ventilation passages 13 to the area of the cushion sheet ranges from 6% to 8%. In the rear portions C, G and K of the cushion seats of the chairs, a ratio of the area of ventilation passages 13 to the area of the cushion sheet ranges from 7% to 10%. As such, in the present invention, according to the degree to which the weight of the user is applied to a part of the chair, a ratio of the area of the ventilation passages 13 to the area of the cushion sheet can be ascertained. For example, in the case of a part of the chair to which a high proportion of the weight of the user is applied, an area ratio of the ventilation passages 13 to the cushion sheet is relatively high, thus compensating for a reduction in the amount of ventilation air in the ventilation passages 13 due to a reduction of the widths thereof.

In the present invention, fire retardant material is used to make the thermal fusion polyurethane sponge layer 23. Hence, the present invention can provide a fire retardant cushion sheet.

Meanwhile, in the present invention, a plastic inner plate 25 having a curvature corresponding to that of the frame 51 of the chair may be attached to the rear surface of the cushion sheet 20, thus forming a cushion sheet assembly 28. To attach the plastic inner plate 25 to the rear surface of the frame 51 of the chair, a bias 26 is sewed to the edge of the cushion sheet 20. Thereafter, the inner plate is placed on the rear surface of the cushion sheet 20 provided with the bias 26. The edge of the inner plate is covered with the bias 26, and then the bias 26 is tensely extended and attached to the rear surface of the inner plate 25 using tacker pins.

As such, in the case where the cushion sheet assembly 28, which is manufactured by attaching the inner plate 25 to the rear surface of the cushion sheet, is separately manufactured before the chair is assembled, the assembly of the cushion sheet 20 can be conducted separately from the assembly of the chair. In addition, when a finished product of the chair is delivered, because the cushion sheet assembly 28 is to be assembled separately, it can be separately packed, thereby also prevented from being contaminated. As well, when necessary, the cushion sheet assembly 28 may be separated from the chair and washed. As such, the seat and back of the chair can be separated from the frame of the chair. Hence, the user may replace the seat and back of the chair with new ones by purchasing a new cushion sheet assembly 28 and by replacing the existing cushion sheet assembly with the new one.

### ADVANTAGEOUS EFFECTS

As described above, the present invention provides a cushion sheet for a chair which has structure and shape corresponding to a human body and ensures cushion stability. Furthermore, superior ventilation ability is ensured. The cushion sheet includes a plurality of cushion cells, which are sized and arranged depending on where the cushion cells 12 contact which parts of the user's body. In addition, when the cushion sheet is attached to the frame of the chair, the curvature of the frame of the chair is expressed through the cushion sheet. As well, the cushion sheet can be designed in various colors. Ventilation passages are formed between the cushion cells. The external appearance of the cushion sheet is graceful, elegant and dignified. Moreover, the present invention can be easily adapted to mass production, the manufacturing process thereof is simple, and the quality control thereof is facilitated.

### BRIEF DESCRIPTION OF THE DRAWINGS

FIG. 1 is a picture of a chair provided with a cushion sheet, according to a first embodiment of the present invention;

FIG. 2 is a picture of a chair provided with a cushion sheet, according to a second embodiment of the present invention;

FIG. 3 is a picture of a chair provided with a cushion sheet, according to a third embodiment of the present invention;

FIG. 4 is an exploded view showing a cover sheet, a sponge layer and a base sheet according to the present invention;

FIG. 5 is a view showing the cover sheet adhered to the sponge layer;

FIG. 6 is a view showing the base sheet adhered to the sponge layer;

FIG. 7 is a view showing a state in which the sponge layer adhered with the base sheet and the cover sheet is set in a mold;

FIG. 8 is a view showing a process of shaping the cushion sheet using the mold;

FIG. 9 is a view of the cushion sheet separated from the mold; and

FIG. 10 is a side view of a cushion sheet assembly.

### DESCRIPTION OF THE ELEMENTS IN THE DRAWINGS

11 adhesion part, 12 cushion cell, 13 ventilation passage, 21 cover layer, 22 base layer, 23 thermal fusion polyurethane sponge layer, 25 inner plate, 28 cushion sheet assembly, 41 upper mold, 42 forming punch, 43 lower mold

### BEST MODE FOR CARRYING OUT THE INVENTION

### First Embodiment

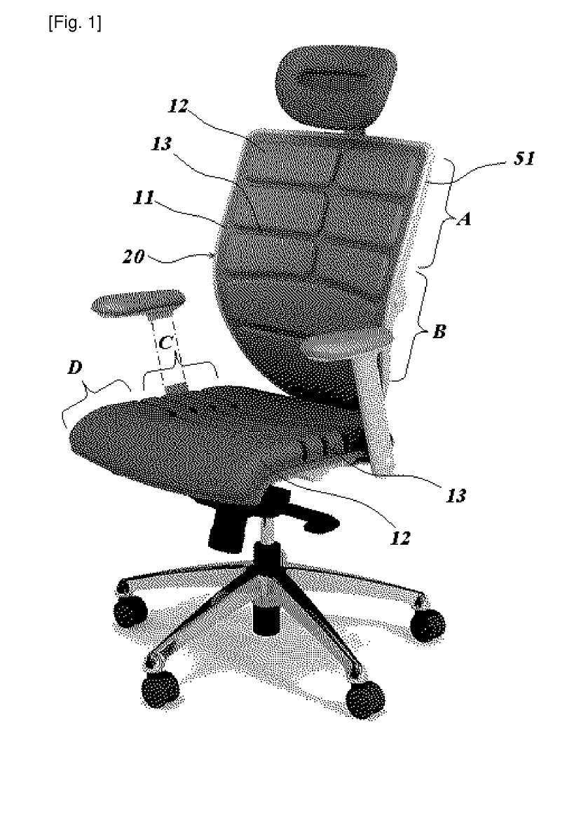

As shown in FIG. 1, each of a cushion sheet and a frame 51 of a chair has back parts A and B and seat parts C and D, which have curvatures corresponding to a curved outline of a human body. The cushion sheet of the embodiment of FIG. 1 is attached to the frame of the chair such that the curvature of the frame is visibly maintained by the cushion cells 12, which are provided on the back parts A and B and the seat parts C and D of the cushion sheet. According to a parts of the human body, in the upper portion A of the back part, cushion cells 12 and ventilation passages 13 have arrangement corresponding to the shapes of the backbone and rib muscles of the user and contact the upper portion of the back of the user. In the upper portion B of the back part, cushion cells 12 and ventilation passages 13, which extend relatively long lengths in the lateral direction, contact the lower portion of the back of the user. The rear portion C of the seat part is a portion, on which the weight of the user is most directly applied, so that many cushion cells 12, each of which has a relatively small size, and many ventilation passages 13 are provided in the rear portion C to reliably ensure the ventilation ability and increase the stability of the cushion sheet. The front portion D of the seat part includes a cushion cell having a relatively simple shape, because a low portion of the weight of the user is applied thereto and little ventilation ability is required but the superior durability is necessary.

As such, the cushion sheet of the present invention shown in FIG. 1 is designed in consideration of the suitability to the human body, the cushion stability and the ventilation ability.

### Second Embodiment

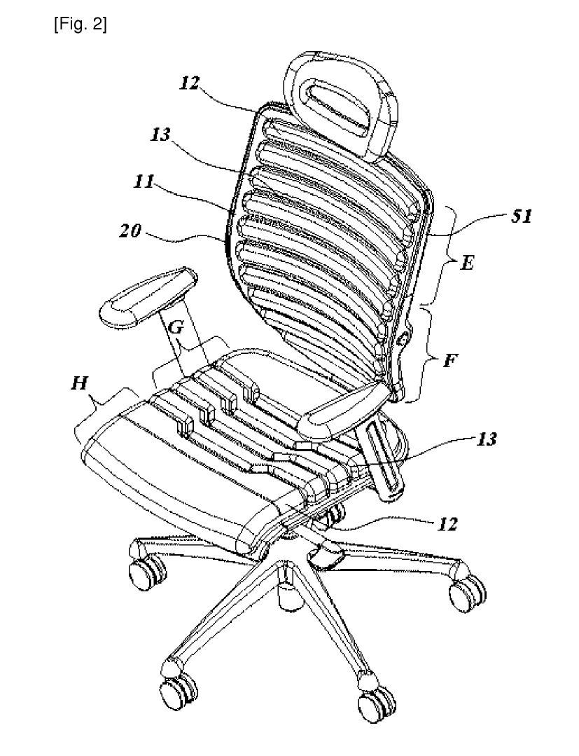

As shown in FIG. 2, each of a cushion sheet and a frame 51 of a chair has back parts E and F and seat parts G and H, which have curvatures corresponding to a curved outline of a human body. The cushion sheet of the embodiment of FIG. 2 is attached to the frame of the chair such that the curvature of the frame is visibly expressed by the cushion cells 12, which are provided on the back parts E and F and the seat parts G and H of the cushion sheet. According to parts of the human body, in the upper portion E of the back part, cushion cells 12 and ventilation passages 13, which extend relatively long lengths in the lateral direction, contact the upper portion of the back of the user. In the lower portion F of the back part, cushion cells 12 and ventilation passages 13, which also extend relatively long lengths in the lateral direction, contact the lower portion of the back of the user. The rear portion G of the seat part is a portion, on which the weight of the user is most directly applied. In the rear portion G, cushion cells 12 and ventilation passages 13 are sectioned into three sections in the lateral direction and are sectioned into four sections in the front and rear directions to reliably ensure the ventilation ability and increase the stability of the cushion sheet. The front portion H of the seat part includes a single cushion cell having a relatively wide area, because a small portion of the weight of the user is applied thereto and little ventilation ability is required but the superior durability is necessary.

As such, the cushion sheet of the present invention shown in FIG. 2 is designed in consideration of the suitability to the human body, the cushion stability and the ventilation ability.

### Third Embodiment

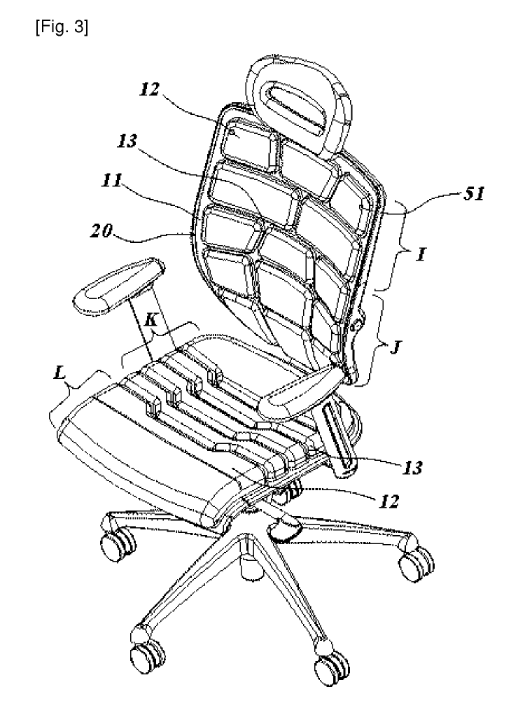

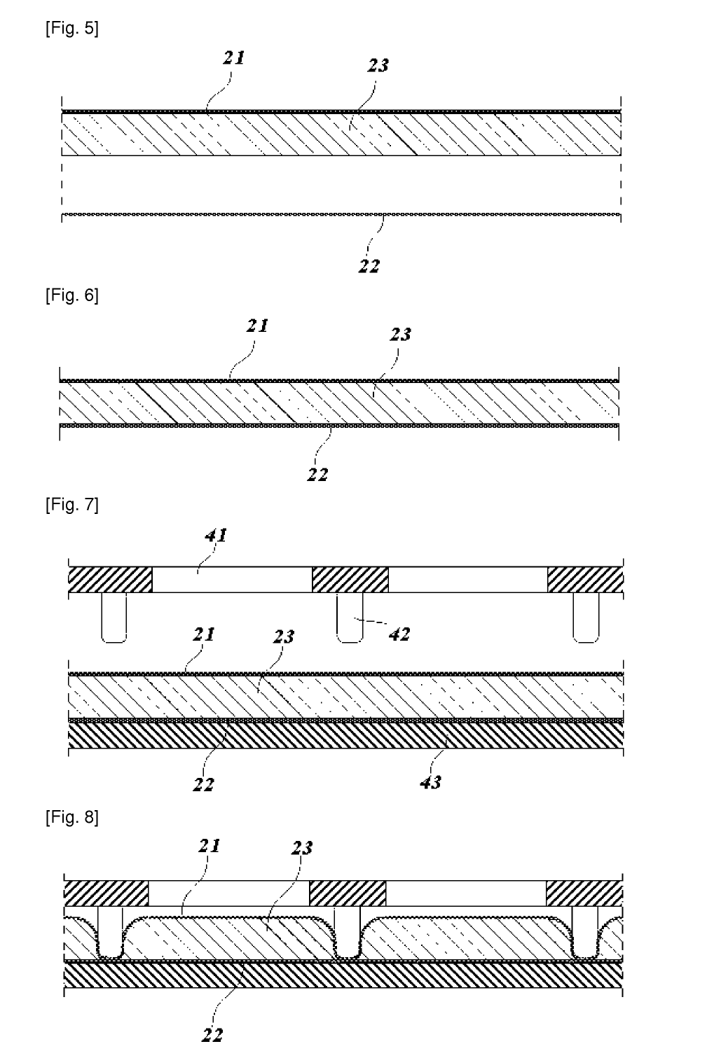

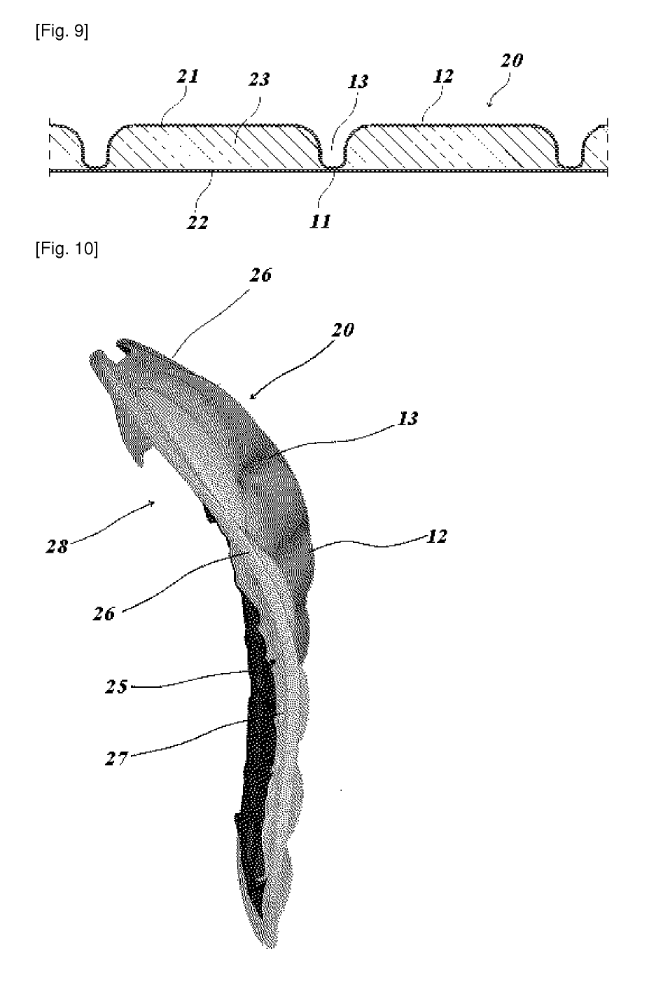

As shown in FIG. 3, each of a cushion sheet and a frame 51 of a chair has back parts I and J and seat parts K and L, which have curvatures corresponding to a curved outline of a human body. The cushion sheet of the embodiment of FIG. 3 is attached to the frame of the chair such that the curvature of the frame is exposed outside through cushion cells 12, which are provided on the back parts I and J and the seat parts K and L of the cushion sheet. According to a part of the human body, in the upper portion I and the lower portion J of the back part, cushion cells 12 and ventilation passages 13 are arranged into a tortoise-shell shape and contact the back of the user. In the rear portion K, cushion cells 12 and ventilation passages 13 are sectioned into three sections in the lateral direction and are sectioned into four sections in the front and rear directions to reliably ensure the ventilation ability and increase the stability of the cushion sheet. The front portion L of the seat part includes a single cushion cell having a relatively wide area, because a small portion of the weight of the user is applied thereto and little ventilation ability is required but the superior durability is necessary.

As such, the cushion sheet of the present invention shown in FIG. 3 is designed in consideration of the suitability to the human body, the cushion stability and the ventilation ability.

### Fourth Embodiment

The cushion sheet according to the present invention is manufactured by the following method.

One surface of a thermal fusion polyurethane sponge layer I, which has a thickness of 17 mm, is heated by a flame, such that a sponge hot melt, which exhibits adhesive force when being hardened, is formed on the surface of the sponge layer I and is relatively thin. Thereafter, a cover layer, which is made of elastic polyester fabric of a grammage 180 g/m², is placed on the surface of the sponge layer I. While the cover layer is compressed to the sponge layer I, the cover layer and the sponge layer are cooled. Thereby, the cover layer is adhered to the surface of the sponge layer I.

Subsequently, one surface of a thermal fusion polyurethane sponge layer II, which has a thickness of 17 mm, is heated by a flame, such that a sponge hot melt, which exhibits adhesive force when being hardened, is formed on the surface of the sponge layer II and is relatively thin. Thereafter, a base layer, which is made of filament gauze of a grammage 10 g/m², is placed on the surface of the sponge layer II. While the base layer is compressed to the sponge layer II, the base layer and the sponge layer are cooled. Thereby, the base layer is adhered to the surface of the sponge layer I.

The two sheets of the thermal fusion polyurethane sponge layers I and II overlap each other such that the cover layer and the base layer are disposed on the outside.

The sponge layered sheet, which has a sandwich shape in which the sponge layer I and the sponge layer II overlap each other between the base layer and the cover layer, is placed between a planar lower mold and an upper mold, which has ventilation passage forming punches. Thereafter, the forming punches of the upper mold heats and compresses the upper surface of the cover layer, thus forming cushion cells and ventilation passages. Simultaneously, portions of the cover layer corresponding to the ventilation passages are adhered to the base layer using a hot melt, which is formed by melting a portion of the sponge layer corresponding to the ventilation passages, thus forming an adhesion part.

To maintain the shape of the cushion sheet formed at the shaping step, the hot melt, which has been applied to the portions of the cover layer and the base layer corresponding to the adhesion part, is cooled and hardened. Subsequently, the cushion sheet is removed from the mold, thus completing the process of manufacturing the cushion sheet.

### INDUSTRIAL APPLICABILITY

Products according to the present invention have been sold in Republic of Korea and regions of Southeast Asia since 2008.

1. A cushion sheet for a chair, comprising:
a structure, including an adhesion part having a curvature corresponding to a curvature of a designed frame of the chair, a plurality of cushion cells formed by the adhesion part, and ventilation passages defined on the adhesion part between the cushion cells, wherein
each of the plurality of cushion cells includes a base layer, a cover layer and a sponge layer, the sponge layer being provided between the base layer and the cover layer to elastically support the cover layer, and
the ventilation passages are defined by extending portions of the cover layer around the cushion cells such that extended portions of the cover layer are brought into close contact with the base layer, and the adhesion part is formed by adhering the extended portions of the cover layer to the base layer using a sponge hot melt formed by melting portions of the sponge layer corresponding to the ventilation passages.

2. The cushion sheet for the chair according to claim 1, wherein each of the ventilation passages has a width ranging from 1 cm to 4 cm, and an area ratio of the ventilation passages to the cushion sheet ranges from 5% to 15% depending on location as related to parts of a body of a user.

3. The cushion sheet for the chair according to claim 1, wherein the cushion cells have an identical thickness and have planar shapes, the cushion cells being arranged such that the cushion sheet has a curvature corresponding to the curvature of the frame of the chair.

4. The cushion sheet for the chair according to claim 1, wherein the cover layer is made of an elastic polyester fabric of a grammage ranging from 50 g/m² to 250 g/m².

5. The cushion sheet for the chair according to claim 1, wherein the sponge layer is made of a thermal fusion polyurethane sponge, and the sponge layer, which is interposed between the cover layer and the base layer, has a thickness ranging from 2 cm to 5 cm.

6. The cushion sheet for the chair according to claim 1, wherein a plastic inner plate is attached to a rear surface of the cushion sheet, the plastic inner plate having a curvature corresponding to the curvature of the frame of the chair.

7. A method of manufacturing a cushion sheet for a chair, comprising the steps of:
forming a sponge hot melt on a first surface of a sponge layer by heating and melting the first surface of the sponge layer using a flame, the sponge layer being made of a thermal fusion polyurethane sponge, which is melted at a temperature ranging from 110° C. to 160° C. and has an adhesive force when being hardened, applying a cover layer, made of an elastic polyester fabric which withstands temperatures of 170° C., to the first surface of the sponge layer under pressure, and cooling the sponge layer and the cover layer, thus adhering the cover layer to the first surface of the thermal fusion polyurethane sponge layer;
forming a sponge hot melt on a second surface of the thermal fusion polyurethane sponge layer by heating and melting the second surface of the sponge layer using a flame, applying a base layer made of a thermal resistant gauze paper, which withstands temperatures of 170° C., to the second surface of the sponge layer under pressure, and cooling the sponge layer and the base layer, thus adhering the base layer to the second surface of the thermal fusion polyurethane sponge layer;
placing the thermal fusion polyurethane sponge layer, to which the base layer and the cover layer are adhered, between a lower mold and an upper mold, having ventilation passage forming punches, compressing the first surface of the sponge layer at a pressure ranging from 80 kg/cm² to 100 kg/cm² using the ventilation passage forming punches heated to a temperature ranging from 150° C. to 170° C. so that cushion cells are formed in the sponge layer on the base layer and ventilation passages are simultaneously formed, and applying a sponge hot melt, formed by melting portions of the sponge layer corresponding to the ventilation passages, to the base layer and the cover layer, the base layer being brought into close contact with the cover layer; and
adhering the cover layer to the base layer by cooling and hardening the sponge hot melt, which is applied to portions of the base layer and the cover layer corresponding to the ventilation passages.
